(19) United States
(12) Patent Application Publication
(10) Pub. No.: US 2017/0195425 A1
(43) Pub. Date: Jul. 6, 2017

(54) Method and Electronic Device for Remotely Locking a Mobile Terminal

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Jianheng TIAN, Beijing (CN)

(21) Appl. No.: 15/242,267

(22) Filed: Aug. 19, 2016

Related U.S. Application Data
(63) Continuation of application No. PCT/CN2016/089250, filed on Jul. 7, 2016.

(30) Foreign Application Priority Data
Dec. 30, 2015 (CN) 201511021430.2

(51) Int. Cl. H04L 29/08; H04L 29/06; H04L 12/24

(52) U.S. Cl. CPC H04L 67/125; H04L 41/0803; H04L 67/42; H04W 88/02

(57) ABSTRACT

The present disclosure discloses a method and electronic device for remotely locking a mobile terminal, wherein the method is applied to a mobile terminal and includes: receiving and saving a lock password that is input; checking the content of a received message after receiving the message and before displaying the message; judging whether the content of the received message is the lock password; and enabling a message lock function and directly deleting any messages received afterwards without displaying them if it is determined that the content of the received message is the lock password. The electronic device includes at least one processor and a memory communicably connected with the at least one processor, wherein instructions executable by the at least one processor are stored in the memory, and cause the at least one processor to carry out the method for remotely locking a mobile terminal.

### CROSS-REFERENCE TO RELATED APPLICATION

This application is a continuation of International PCT Patent Application No. PCT/CN2016/089250, filed Jul. 7, 2016 (attached hereto as an Appendix), and claims benefit/priority of Chinese patent application No. 201511021430.2, filed with the State Intellectual Property Office of China on Dec. 30, 2015, which are all incorporated herein by reference in entirety.

### TECHNICAL FIELD

The present disclosure relates to mobile device security management, and in particular, to a method and an electronic device for remotely locking a mobile terminal.

### BACKGROUND

With the popularization of intelligent mobile terminals, various applications may be installed on a mobile terminal, including bank and shopping website, etc. For convenience, people usually allow an application to remember a card number or an account, thus it only requires to input a password during logging in the application.

However, once a mobile terminal is lost or stolen, the thief may reset the password of the card number or the account via an identifying code which is provided in case the user forgets the password, and then logs in the application; thus, a great hidden risk may be induced, which may cause information loss and property loss to the user.

Generally, in the prior art, user information security is guaranteed by setting a power-on password or locking a lost mobile terminal so as to make the mobile terminal unable to be powered on. However, others may still unlock the mobile terminal by cracking the password; once the power-on lock is unlocked, the mobile terminal will not have any defensive measures. Moreover, when others fail to crack the password, the mobile terminal will give an input error warning, which is convenient for the cracker to realize in time whether the password input is correct, and hence is disadvantageous for user information security of the mobile terminal.

### SUMMARY

Therefore, it is an object of the present disclosure to put forward a method and an electronic device for remotely locking a mobile terminal, thereby effectively improving the security protection for the information on a mobile terminal, such as account password and the like.

Based on the above object, the disclosure provides a method for remotely locking a mobile terminal, which is applied to a mobile terminal, including:

receiving and saving a lock password that is input;

checking the content of a received message after receiving the message and before displaying the message;

judging whether the content of the received message is the lock password; and

enabling a message lock function and directly deleting any messages received afterwards without displaying them if it is determined that the content of the received message is the lock password.

In some implementation modes, the step of checking the content of the received message further includes:

checking the length of the message content, and judging whether the length of the message content is the same as the length of the lock password;

if yes, judging whether the content of the message received is the lock password.

In some implementation modes, after the enabling a message lock function, the method further includes:

saving the number that sends the message received as a rescue number, and sending a notification message indicating that the message lock function has been enabled to the rescue number.

In some implementation modes, after the enabling a message lock function, the method further includes:

periodically acquiring a location information of the user mobile terminal, and sending the location information to the rescue number.

In some implementation modes, the method further includes:

normally displaying the content of the received message if it is determined that the content of the received message is not the lock password.

In some implementation modes, the step of the step of directly deleting any messages received afterwards without displaying them further includes: processing the messages on a bottom layer of the user mobile terminal, without reporting the message to a display module of the mobile terminal.

In some implementation modes, the method further includes:

setting an unlock operation event in the user mobile terminal for disabling the message lock function; and

disabling the message lock function if the unlock operation event is detected when the message lock function has been enabled on the user mobile terminal.

In some implementation modes, there further includes a network end, wherein the lock password is stored in the user mobile terminal locally or in the network end.

According to a second aspect, the disclosure further provides a computer storage medium on which a program is stored, when executed, the program may carry out part of or all of the steps in each implementation mode of the above method for remotely locking a mobile terminal according to the disclosure.

According to a third aspect, the disclosure further provides an electronic device that includes at least one processor and a memory, wherein instructions executable by the at least one processor are stored in the memory, and the instructions are configured to carry out any one of the above methods for remotely locking a mobile terminal according to the disclosure.

It may be seen from above that, in the method for remotely locking a mobile terminal according to the disclosure, a user sets a lock password in his/her own mobile terminal, then the mobile terminal of the user will judge whether the content of each message received is the lock password by comparison, and once the lock password is received, a message lock function will be enabled, and any messages received afterwards will be directly deleted without being displayed. Therefore, once the mobile terminal of the user is lost, the user may remotely control his/her lost mobile terminal via any other mobile terminal, so that the lost mobile terminal can no longer receive any messages (including an identifying code for password reset), thereby it may be prevented that the one who steals the mobile terminal may tamper and embezzle an app account on the mobile terminal via a message reset function. Moreover, after such a message lock has been set, it would be very difficult for others to notice that messages have been locked; further, lock passwords are more arbitrary in comparison with common passwords and hence are more difficult to be cracked, thereby information security of account password and the like can be effectively protected.

### BRIEF DESCRIPTION OF THE DRAWINGS

In order to more clearly illustrate the technical solutions of the embodiments of the disclosure or of the prior art, the drawings that are needed in the description of the embodiments or the prior art will be briefly introduced below. Apparently, the drawings in the description below merely illustrate some embodiments of the invention, and other drawings may also be obtained by one of ordinary skills in the art according to these drawings without creative work.

FIG. 1 is an overall schematic flow chart of the method for remotely locking a mobile terminal according to the disclosure;

FIG. 2 is a schematic flow chart of a first embodiment of the method for remotely locking a mobile terminal according to the disclosure;

FIG. 3 is a schematic diagram showing the module structure of a system for remotely locking a mobile terminal according to the disclosure; and

FIG. 4 is an structural diagram of an electronic device according to the disclosure.

### DETAILED DESCRIPTION

The disclosure will be further discussed in detail below in conjunction with the specific embodiments together with the drawings to make the objects, technical solutions and advantages of the disclosure more clear.

It should be noted that, all the expressions of “first” and “second” employed in the embodiments of the disclosure are used for distinguishing two different entities or parameters with the same name from each other. Thus, it may be seen that “first” and “second” are merely used for the sake of a convenient description, rather than limiting the embodiments of the disclosure, and this will not be specifically explained in the subsequent embodiments.

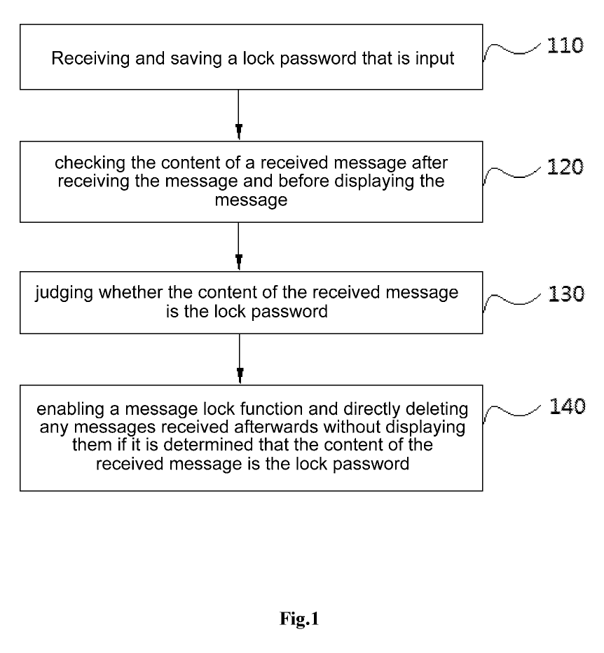

Referring to FIG. 1, it is an overall schematic flow chart of a method for remotely locking a mobile terminal according to the disclosure.

The disclosure provides a method for remotely locking a mobile terminal, which is applied to a mobile terminal, wherein the method includes:

In step 110: an input lock password is received and saved;

In step 120: after receiving a message, the content of the received message is checked before the message is displayed;

In step 130: it is judged whether the content of the received message is the lock password; and

In step 140: if it is determined that the content of the received message is the lock password, a message lock function is enabled and any messages received subsequently are deleted directly without being displayed.

Preferably, the step of checking the content of the message received in step 120 further includes:

checking the length of the message content, and judging whether the length of the message content is the same as the length of the lock password; and

if yes, judging whether the content of the message received is the lock password.

Preferably, the step of judging whether the content of the received message is the lock password in step 130 further includes:

comparing the content of the received message with the lock password byte by byte, and judging whether bytes at corresponding locations are the same as each other;

determining that the content of the received message is not the lock password if one different byte is detected; and

determining that the content of the received message is the lock password if all the bytes are the same.

Preferably, after enabling a message lock function in step 140, the method further includes:

saving the number that sends the received message as a rescue number, and sending a notification message indicating that the message lock function has been enabled to the rescue number.

Further, after enabling a message lock function, the method further includes:

periodically acquiring a location information of the user mobile terminal, and sending the location information to the rescue number.

Preferably, the step of directly deleting any messages received subsequently without displaying them in step 140 further includes: processing the message on the modem side without reporting it to the UI.

Preferably, the method for remotely locking a mobile terminal further includes:

normally displaying the content of the received message if it is determined that the content of the received message is not the lock password.

Optionally, the method for remotely locking a mobile terminal further includes:

setting an unlock operation event in the user mobile terminal for disabling the message lock function; and

disabling the message lock function if the unlock operation event is detected when the message lock function has been enabled on the user mobile terminal.

Optionally, the method for remotely locking a mobile terminal further includes: storing the lock password in the user mobile terminal locally or in a network end of the mobile terminal.

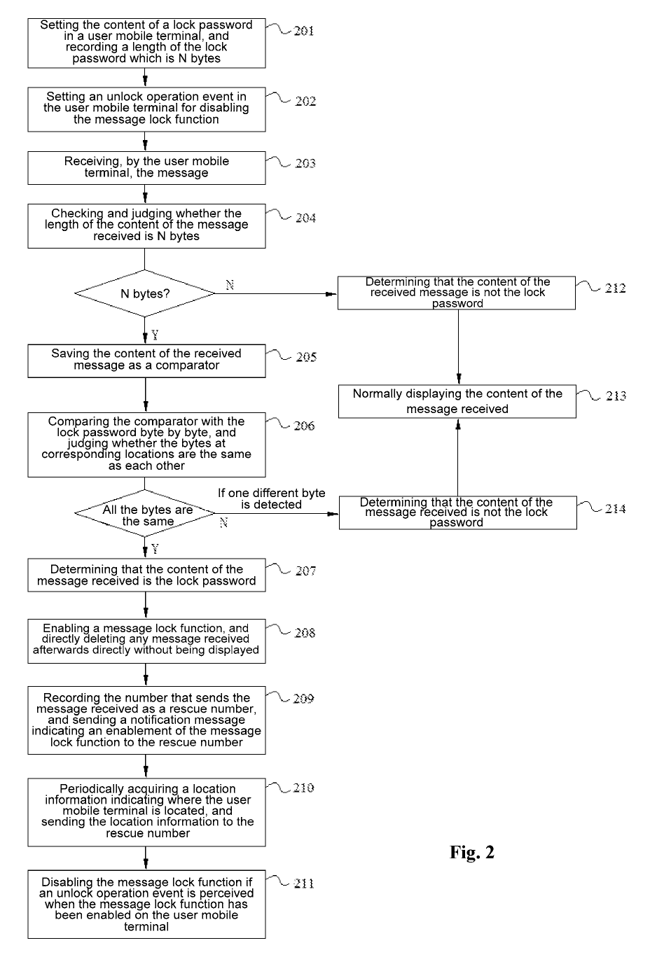

Referring to FIG. 2, it is a schematic flow chart of a first embodiment of the method for remotely locking a mobile terminal according to the disclosure.

The disclosure further provides a more specific embodiment of a method for remotely locking a mobile terminal, which includes:

In step 201: the content of a lock password is set in a user mobile terminal.

In some user mobile terminals, this function may be selectively enabled or disabled according to user's wish. In factory setting, this function is defaultly disabled, while a user may enable this function by selecting: Settings→Other Advanced Settings→Security And Privacy→Remotely Locking Mobile Phone→Enabled on the menu of user mobile terminal.

In some user mobile terminals, the content of the lock password is set defaultly, and a user may modify the content of the lock password via an option in the setting menu; after modification, it requires to input a password twice for confirmation; after confirmation, the user mobile terminal will save the new password. Wherein, the language for the lock password may be English, Chinese or digits, and the length as well as the case-sensitivity of the content is not limited.

Optionally, the lock password may be stored in the user mobile terminal locally or in a network end of the mobile terminal. Wherein, the network end may store the lock password to a cloud terminal by using a cloud terminal account bound to the user mobile terminal.

Preferably, the step of setting the content of a lock password in a user mobile terminal further includes: recording a length of the lock password which is N bytes.

In step 202: an unlock operation event is set in the user mobile terminal for disabling the message lock function.

This step may be carried out before or after step 201 or may be carried out concurrently with Step 201, and the unlock operation event may be selected from one of the following:

setting an unlock password as the content of a message, and disabling the current message lock function by sending the unlock password to one's own mobile terminal via other mobile terminals;

or, setting a password unlocker in the user mobile terminal, which can only be tried for 3 times;

or, setting a gesture unlocker in the user mobile terminal, which can only be tried for 3 times;

or, setting a fingerprint unlocker in the user mobile terminal, which can only be tried for 3 times.

In step 203: the message is received by the user mobile terminal.

In step 204: it is checked and judged whether the length of the content of the message received is N bytes.

In step 212: if the length is not N bytes, it is determined that the content of the received message is not the lock password and it turns to step 208;

In step 205: if the length is N bytes, the content of the received message is stored as a comparator.

By these steps, the mobile terminal of the user may first exclude a message that obviously cannot be the lock password, wherein the message that obviously cannot be the lock password means that even a length of the message content is different from that of the lock password; afterwards, such a message will be normally displayed to the user directly, thus a time waste as well as a memory waste caused by directly comparing message content may be prevented.

The purpose of the step of checking the content of the message received is to perform step 203, and said step is processed at the modem side, without being reported to the UI, thus nothing will be displayed on the UI. As a result, the person who currently carries the user mobile terminal will not perceive the internal action of the user mobile terminal, and the user mobile terminal may perform operation on the message on the bottom layer without being perceived by the person.

In step 203, a part of the messages that are surely not the lock password have been excluded by comparing the length of the message, and these messages are reported to the UI and the contents of the messages are displayed. However, for a message with the same length as the lock password, it needs to further compare the content of the message with the lock password; the overall steps thereof are as follows:

the content of the message received is compared with the content of the lock password;

if the content of the message received is not completely same as the content of the lock password, it is determined that the content of the message received is not the lock password; and

if the content of the message received is completely same as the content of the lock password, it is determined that the content of the message received is the lock password, and it turns to step 208.

Generally, when a user mobile terminal is lost, the user may edit a message with the content thereof being the lock password via any other terminals that have a message function, and send the message to the user mobile terminal.

Preferably, in coordination with steps 204-205, the step of determining whether the content of the message received is the lock password further includes:

in step 206: the comparator is compared with the lock password byte by byte, and it is judged whether the bytes at corresponding locations are the same as each other;

in step 214: it is determined that the content of the message received is not the lock password if one different byte is detected; and

in step 207: it is determined that the content of the message received is the lock password if all the bytes are the same, and it turns to step 208.

In such a comparison mode, the time needed for performing judging operation may be saved, because once a different byte in a corresponding location is detected, the content of the message received cannot be completely same as the content of the lock password; at this point, it may be directly determined that the content of the message received is not the lock password.

Wherein, the comparison may be performed byte by byte sequentially; for example, the first byte of the content of the message received is compared with the first byte of the lock password; if they are the same, the second byte of the content of the message received is compared with the second byte of the content of the message received; if they are the same, it continues to compare the third bytes of the two, and so on. Or, the comparison operation may not be performed sequentially; for example, an N^{th} bytes of the content of the message received may be randomly chosen to compare with the N^{th} bytes of the lock password, and if they are the same, another uncompared byte of the content of the message received may be randomly chosen for continuously performing comparison, until all the bytes are compared; wherein, if any different byte is detected, it will be directly determined that the content of the message received is not the lock password.

In step 208: if it is determined that the content of the message received is the lock password, a message lock function is enabled and any message received afterwards is deleted directly without being displayed.

Preferably, after enabling a message lock function, the method further includes:

in step 209: the number that sends the message received is recorded as a rescue number, and a notification message indicating an enablement of the message lock function is sent to the rescue number;

in step 210: a location information indicating where the user mobile terminal is located is acquired periodically, and the location information is sent to the rescue number.

The location information of the mobile terminal may be obtained by a GPS module in the user mobile terminal, and the location information will be converted into a character form and sent to the rescue number in the form of a message, or a map link will be created and sent to the rescue number in the form of a message.

Step 209 and Step 210 are still processed at the modem side, without reporting to the UI, thus nothing will be display on the UI. As a result, the person who currently carries the user mobile terminal will not perceive the internal action of the user mobile terminal, and the user mobile terminal may perform operation on the message on the bottom layer without being perceived by the person.

In step 213: the content of the message received will be normally displayed if it is determined that the content of the message received is not the lock password; and

In step 211: when the message lock function has been enabled on the user mobile terminal, the message lock function will be disabled if an unlock operation event is perceived.

If the message lock function is not enabled currently, the user mobile terminal will not respond to the unlock operation event.

It may be seen from above that, in the method for remotely locking a mobile terminal according to the disclosure, a user sets a lock password in his/her own mobile terminal, then the mobile terminal of the user will judge whether the content of each message received is the lock password by comparison, and once the lock password is received, a message lock function will be enabled, and any message received afterwards will be directly deleted without being displayed. Therefore, once the mobile terminal of the user is lost, the user may remotely control his/her lost mobile terminal via any other mobile terminal, so that the lost mobile terminal can no longer receive any messages (including an identifying code for password reset), thereby it may be prevented that the one who steals the mobile terminal may tamper and steal an app account on the mobile terminal via a message reset function. Moreover, after such a message lock has been set, it would be very difficult for others to notice that messages have been locked; further, lock passwords are more arbitrary in comparison with common passwords and hence are more difficult to be cracked, thereby information security of account password and the like can be effectively protected.

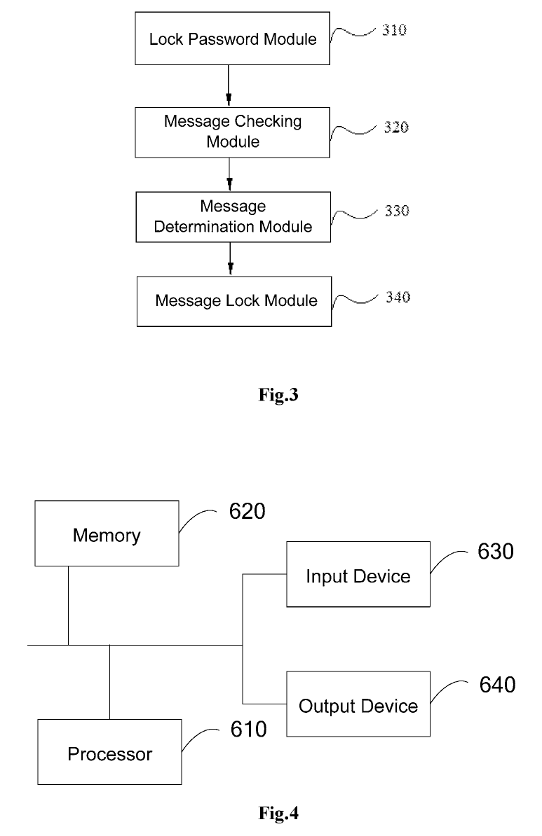

Referring to FIG. 3, it is a schematic diagram showing a module structure of a system for remotely locking a mobile terminal according to the disclosure.

The disclosure further provides a system for remotely locking a mobile terminal, which is applied to a mobile terminal, wherein the system includes:

a lock password module 310, configured for receiving and saving a lock password that is input;

a message checking module 320, configured for checking the content of a message received after receiving the message and before displaying the message;

a message determination module 330, configured for determining whether the content of the message received is the lock password; and

a message lock module 340, configured for enabling a message lock function and directly deleting any message received afterwards without displaying it if it is determined that the content of the message received is the lock password.

Preferably, the message checking module 320 is further configured for: checking the length of the content of the message, and judging whether the length of the message content is the same as the length of the lock password; and if yes, it turns to the message determination module 330.

Preferably, the message determination module 330 is further configured for:

comparing the content of the message received with the lock password byte by byte, and judging whether bytes at corresponding locations are the same as each other;

determining that the content of the received message is not the lock password if one different byte is detected; and

determining that the content of the received message is the lock password if all the bytes are the same.

Preferably, after the message lock module 340, the system further includes:

a rescue number module, configured for saving the number that sends the received message as a rescue number, and sending a notification message indicating that the message lock function has been enabled to the rescue number.

Moreover, the rescue number module is further configured for periodically acquiring the location information of the user mobile terminal, and sending the location information to the rescue number.

Preferably, the system further includes:

a mobile terminal display module, configured for normally displaying the content of the received message if it is determined that the content of the received message is not the lock password.

Preferably, the message determination module and the message lock module both process the message on a bottom layer of the user mobile terminal, without reporting the message to a display module of the mobile terminal.

Optionally, the system further includes:

a message lock disabling module, which is configured for:

setting an unlock operation event in the user mobile terminal; and

disabling the message lock function if the unlock operation event is detected when the message lock function has been enabled on the user mobile terminal.

Optionally, the system further includes: a network module configured for storing data at the network end, wherein the lock password is stored in the local lock password module of the user mobile terminal or in the network module.

It may be seen from above that, in the system for remotely locking a mobile terminal according to the disclosure, a user sets a lock password in a lock password module of the his/her own mobile terminal, then it will be judged via comparison whether the content of each message received is the lock password, and once the lock password is received, a message lock function will be enabled, and any messages received afterwards will be directly deleted without being displayed. Therefore, once the mobile terminal of the user is lost, the user may remotely control his/her lost mobile terminal via any other mobile terminal, so that the lost mobile terminal can no longer receive any messages (including an identifying code for password reset), thereby it may be prevented that the one who steals the mobile terminal may tamper and embezzle an app account on the mobile terminal via a message reset function. Moreover, after such a message lock is set, it would be very difficult for others to notice that the message have been locked; further, lock passwords are more arbitrary in comparison with common passwords and hence are more difficult to be cracked, thereby the information security of account password and the like can be effectively protected.

The above solution of each embodiment of the disclosure may also be used in conjunction with the current power-on password and the power-on lock once stolen, thereby information security of user account password and the like may be improved.

One embodiment of the disclosure further provides a computer storage medium on which a program is stored; when executed, the program may carry out part of or all of the steps in each implementation mode of the method for remotely locking a mobile terminal according to the embodiments shown in FIG. 1-FIG. 2.

FIG. 4 is diagram illustrating a hardware structure of an electronic device for carrying out the method for remotely locking a mobile terminal according to an embodiment of the disclosure. As shown in FIG. 4, the electronic device includes:

at least one processor 610 and a memory 620, wherein only one processor 610 is illustratively shown in FIG. 4.

The electronic device executing the method for remotely locking a mobile terminal may also include: an input device 630 and an output device 640.

The processor 610, memory 620, input device 630 and output device 640 may be connected via a bus or other means, wherein a connecting bus is illustratively shown in FIG. 4.

The memory 620, as a non-volatile computer readable storage medium, may be used to store non-volatile software programs, non-volatile computer executable programs and modules, such as the program commands/modules corresponded to the method for remotely locking a mobile terminal according to the embodiments in the present disclosure. The processor 610, by running non-volatile software programs, commands and modules stored in the memory 620, performs various functional applications and data processing of the server, i.e., carries out the method for remotely locking a mobile terminal according to the above embodiments in the present disclosure.

The memory 620 may include a program storage area and a data storage area, wherein the program storage area may be used to store application programs needed by an operating system or by at least one function, and the data storage area may be used to store data created by running the device for remotely locking a mobile terminal, and the like. Moreover, the memory 620 may include a high speed random access memory, and also may include a non-volatile memory, such as at least one disk memory, flash memory, or other non-volatile solid state memory. According to some embodiments, the memory 620 may optionally include memories that are remotely setup with respect to the processor 610, and these remote memories may be connected to the device for remotely locking a mobile terminal via a network connection. An example of such a network includes, but not limited to, internet, intranet, local area network, mobile communication network, and a combination thereof.

The input device 630 may receive input digital or character information, and generate key signal inputs concerned with user setting and functional control of the device for remotely locking a mobile terminal. The output device 640 may include displaying means such as a display screen.

The at least one module is stored in the memory 620, and, when run by the at least one processor 610, executes the method for remotely locking a mobile terminal according to any one of the above method embodiments.

The above product may excite the method provided by the embodiments of the present disclosure, and has functional modules and beneficial effects corresponded to the executed method. As for technical details that are not elaborated in the present embodiments, reference can be made to the method provided by the embodiments of the present disclosure.

The electronic devices in the embodiments of the present disclosure exist in various forms, including but not limited to:

(1) mobile communication devices, characterized in having a function of mobile communication mainly aimed at providing speech and data communication, wherein such terminal includes: smart phone (such as iPhone), multimedia phone, functional phone, low end phone and the like.;

(2) ultra mobile personal computer devices, which falls in a scope of personal computer, has functions of calculation and processing, and generally has characteristics of mobile internet access, wherein such terminal includes: PDA, MID and UMPC devices, such as iPad;

(3) portable entertainment devices, which can display and play multimedia contents, and includes audio or video player (such as iPod), portable game console, E-book and intelligent toys and portable vehicle navigation devices;

(4) server, a device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned device examples are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer apparatus (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

1. A method for remotely locking a mobile terminal, which is applied to a mobile terminal, comprising:
receiving and saving a lock password that is input;
checking the content of a received message after receiving the message and before displaying the message;
judging whether the content of the received message is the lock password; and
enabling a message lock function and directly deleting any messages received afterwards without displaying them if it is determined that the content of the received message is the lock password.

2. The method according to claim 1, wherein the step of checking the content of the received message further comprises:
checking the length of the message content, and judging whether the length of the message content is the same as the length of the lock password;
if yes, judging whether the content of the message received is the lock password.

3. The method according to claim 1, wherein after the enabling a message lock function, the method further comprises:
saving the number that sends the message received as a rescue number, and sending a notification message indicating that the message lock function has been enabled to the rescue number.

4. The method according to claim 3, wherein after the enabling a message lock function, the method further comprises:
periodically acquiring a location information of the user mobile terminal, and sending the location information to the rescue number.

5. The method according to claim 1, further comprising:
normally displaying the content of the received message if it is determined that the content of the received message is not the lock password.

6. The method according to claim 1, wherein the step of directly deleting any messages received afterwards without displaying them further comprises:
processing the messages on a bottom layer of the user mobile terminal, without reporting the message to a display module of the mobile terminal.

7. The method according to claim 1, further comprising:
setting an unlock operation event in the user mobile terminal for disabling the message lock function; and
disabling the message lock function if the unlock operation event is detected when the message lock function has been enabled on the user mobile terminal.

8. The method according to claim 1, further comprising: a network end, wherein the lock password is stored in the user mobile terminal locally or in the network end.

9. A non-transitory computer storage medium for storing computer executable instructions that are configured for:
receiving and saving a lock password that is input;
checking the content of a received message after receiving the message and before displaying the message;
judging whether the content of the received message is the lock password; and
enabling a message lock function and directly deleting any messages received afterwards without displaying them if it is determined that the content of the received message is the lock password.

10. The non-transitory computer storage medium according to claim 9, wherein the step of checking the content of the received message further comprises:
checking the length of the message content, and judging whether the length of the message content is the same as the length of the lock password;
if yes, judging whether the content of the message received is the lock password.

11. The non-transitory computer storage medium according to claim 9, wherein after the enabling a message lock function, the computer executable instructions are further configured for:
saving the number that sends the message received as a rescue number, and sending a notification message indicating that the message lock function has been enabled to the rescue number.

12. The non-transitory computer storage medium according to claim 11, wherein after the enabling a message lock function, the computer executable instructions are further configured for:
periodically acquiring a location information of the user mobile terminal, and sending the location information to the rescue number.

13. The non-transitory computer storage medium according to claim 9, wherein the computer executable instructions are further configured for:
normally displaying the content of the received message if it is determined that the content of the received message is not the lock password.

14. The non-transitory computer storage medium according to claim 9, wherein the step of directly deleting any messages received afterwards without displaying them further comprises:
processing the messages on a bottom layer of the user mobile terminal, without reporting the message to a display module of the mobile terminal.

15. An electronic device for remotely locking a mobile terminal, comprising:
at least one processor; and
a memory communicably connected with the at least one processor,
wherein instructions executable by the at least one processor are stored in the memory, and the instructions, when being executed by the at least one processor, cause the at least one processor to:
receive and save a lock password that is input; check the content of a received message after receiving the message and before displaying the message;
judge whether the content of the received message is the lock password; and
enable a message lock function and directly delete any messages received afterwards without displaying them if it is determined that the content of the received message is the lock password.

16. The electronic device according to claim 15, wherein the step to check the content of the received message further comprises to:
check the length of the message content, and judge whether the length of the message content is the same as the length of the lock password;
if yes, judge whether the content of the message received is the lock password.

17. The electronic device according to claim 15, wherein after enabling a message lock function, the at least one processor are further caused to:
save the number that sends the message received as a rescue number, and send a notification message indicating that the message lock function has been enabled to the rescue number.

18. The electronic device according to claim 17, wherein after enabling a message lock function, the at least one processor are further caused to:
periodically acquire a location information of the user mobile terminal, and send the location information to the rescue number.

19. The electronic device according to claim 15, wherein the electronic device is configured to:
normally display the content of the received message if it is determined that the content of the received message is not the lock password.

20. The electronic device according to claim 15, wherein the step to directly delete any messages received afterwards without displaying them further comprises to:
process the messages on a bottom layer of the user mobile terminal, without reporting the message to a display module of the mobile terminal.
